(19) United States
(12) Patent Application Publication
(10) Pub. No.: US 2013/0275633 A1
(43) Pub. Date: Oct. 17, 2013

(54) METHOD AND SYSTEM FOR OPERATING ACCESSORY IN TERMINAL AND TERMINAL SUPPORTING THE SAME

(71) Applicant: SAMSUNG ELECTRONICS CO. LTD., Suwon-si (KR)

(72) Inventor: Kiwook HAN, Seongnam-si (KR)

(73) Assignee: Samsung Electronics Co. Ltd., Suwon-si (KR)

(21) Appl. No.: 13/857,791

(22) Filed: Apr. 5, 2013

(30) Foreign Application Priority Data
Apr. 13, 2012 (KR) 10-2012-0038201

(51) Int. Cl. G06F 13/38

(52) U.S. Cl. CPC G06F 13/385
USPC 710/64

(57) ABSTRACT

A method and a system for operating an accessory in a terminal capable of variously differentiating key input signals transceived between a portable terminal and an accessory, and a terminal supporting the same, are provided. The system for operating an accessory device in a terminal includes the terminal including a Universal Serial Bus (USB) port and an ear jack port, and the accessory device configured to simultaneously connect with the USB port and the ear jack port of the terminal, and to transfer a signal corresponding to a key input signal to the terminal through the USB port and the ear jack port.

### PRIORITY

This application claims the benefit under 35 U.S.C. §119(a) of a Korean patent application filed on Apr. 13, 2012 in the Korean Intellectual Property Office and assigned Serial No. 10-2012-0038201, the entire disclosure of which is hereby incorporated by reference.

### BACKGROUND OF THE INVENTION

1. Field of the Invention

The present invention relates to an operation of an accessory device in a terminal. More particularly, the present invention relates to a method and a system for operating an accessory device in a terminal capable of supporting various accessory functions by increasing the number of keys of the accessory device, and a terminal supporting the same.

2. Description of the Related Art

Since a portable terminal supports a specific user function, and the size thereof is small so that a user may carry it, the portable terminal has become ubiquitous in many industrial and living fields. Further, in recent years, a portable terminal integrally supporting various user functions has been introduced. Such a portable terminal provides a screen corresponding to a user function through a display unit while supporting the user function. Accordingly, the user uses a specific user function to consume content items through a screen according to an operation of a corresponding function.

Meanwhile, to support portability of the foregoing portable terminal, an input device or an output device larger than the predetermined size is simplified or is transformed into another structure. However, since an input device or an output device having a predetermined size provide convenience to a user in operating an electronic device, a need for an input device or an output device by users has been increased. For example, according to the related art, an external accessory device such as a speaker is provided and is connected to the portable terminal and is operated so that a speaker function reinforces a limited speaker function of the portable terminal. Further, according to the related art, an external accessory device such as a keyboard is provided to assist a limited construction of an input unit of the portable terminal. To operate the accessory device according to the related art, a Universal Serial Bus (USB) connection between the accessory device and the portable terminal is supported.

However, in a supported accessory USB connection of the related art, there is a limitation on a range of a signal capable of differentiating key input signals from an accessory device, and thus it is difficult to differentiate the predetermined number of signals or greater. In view of a trend where there are an increasing number of key input signals in the accessory device for controlling the portable terminal, such a limited key input environment adversely affects development or operation of the accessory device.

Therefore, a need exists for a technique for operating an accessory device in a terminal capable of supporting various accessory functions by increasing the number of keys of the accessory device.

The above information is presented as background information only to assist with an understanding of the present disclosure. No determination has been made, and no assertion is made, as to whether any of the above might be applicable as prior art with regard to the present invention.

### SUMMARY OF THE INVENTION

Aspects of the present invention are to address at least the above-mentioned problems and/or disadvantages and to provide at least the advantages described below. Accordingly, an aspect of the present invention to provide a method and a system for operating an accessory device in a terminal capable of variously differentiating key input signals transceived between a portable terminal and the accessory device and a terminal supporting the same.

In accordance with an aspect of the present invention, a system for operating an accessory device in a terminal is provided. The system includes a terminal including a Universal Serial Bus (USB) port and an ear jack port, and the accessory device configured to simultaneously connect with the USB port and the ear jack port of the terminal, and to transfer a signal corresponding to a key input signal to the terminal through the USB port and the ear jack port.

In accordance with another aspect of the present invention, a method of operating an accessory device in a terminal is provided. The method includes connecting a USB connector and an ear jack connector of the accessory device with a USB port and an ear jack port of the terminal, respectively, transferring a signal from the accessory device to the terminal through the USB port and the ear jack port, the signal corresponding to a key input signal received by the accessory device, and differentiating, by the terminal, the key input signal of the accessory device based on the signal transferred through the USB port and the ear jack port.

In accordance with another aspect of the present invention, a terminal for supporting an operation of an accessory device is provided. The terminal includes a USB port, an ear jack port, and a controller configured to differentiate a key input signal of the accessory device based on at least one of resistance variation, voltage variation, and current variation detected via the USB port and the ear jack port when the accessory device simultaneously connects with the USB port and the ear jack port.

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other aspects, features, and advantages of certain exemplary embodiments of the present invention will be more apparent from the following description taken in conjunction with the accompanying drawings, in which:

FIG. 1 is a diagram illustrating a configuration of an example of a system for operating an accessory in a terminal according to an exemplary embodiment of the present invention;

FIG. 2 is a diagram illustrating a configuration of another example of a system for operating an accessory in a terminal according to an exemplary embodiment of the present invention;

FIG. 3 is a block diagram illustrating a configuration of a terminal, such as the terminal shown in FIG. 1 or 2, according to an exemplary embodiment of the present invention;

FIG. 4 is a block diagram illustrating a configuration of a controller, such as the controller shown in FIG. 3, according to an exemplary embodiment of the present invention;

FIG. 5 is a block diagram illustrating a configuration of an accessory device according to an exemplary embodiment of the present invention;

FIG. 6 is a flowchart illustrating a method of operating an accessory in a terminal according to an exemplary embodiment of the present invention; and

FIG. 7 is a diagram illustrating a configuration of an example of a system for operating an accessory in a terminal according to another exemplary embodiment of the present invention.

Throughout the drawings, it should be noted that like reference numbers are used to depict the same or similar elements, features, and structures.

### DETAILED DESCRIPTION OF EXEMPLARY EMBODIMENTS

The following description with reference to the accompanying drawings is provided to assist in a comprehensive understanding of exemplary embodiments of the invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. In addition, descriptions of well-known functions and constructions may be omitted for clarity and conciseness.

The terms and words used in the following description and claims are not limited to the bibliographical meanings, but, are merely used by the inventor to enable a clear and consistent understanding of the invention. Accordingly, it should be apparent to those skilled in the art that the following description of exemplary embodiments of the present invention is provided for illustration purpose only and not for the purpose of limiting the invention as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

The size of the elements shown in the drawing may be exaggerated for the purpose of explanation and may not reflect the actual size.

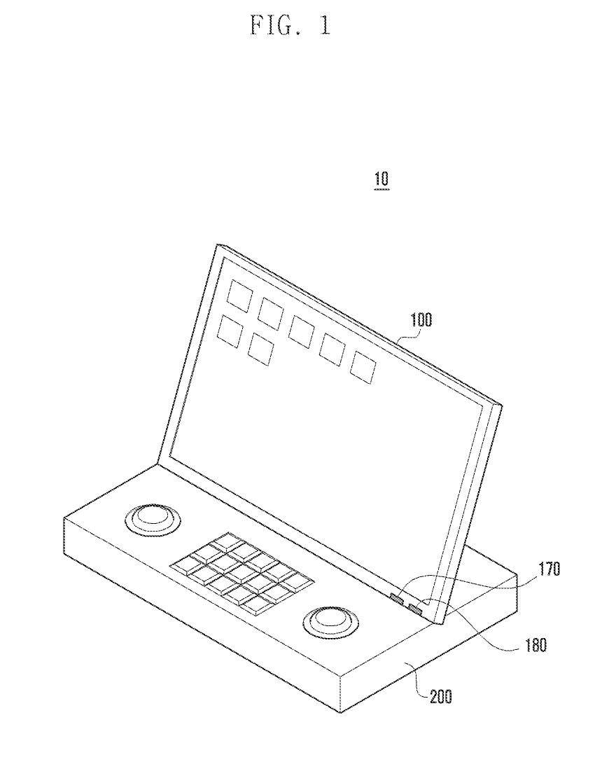

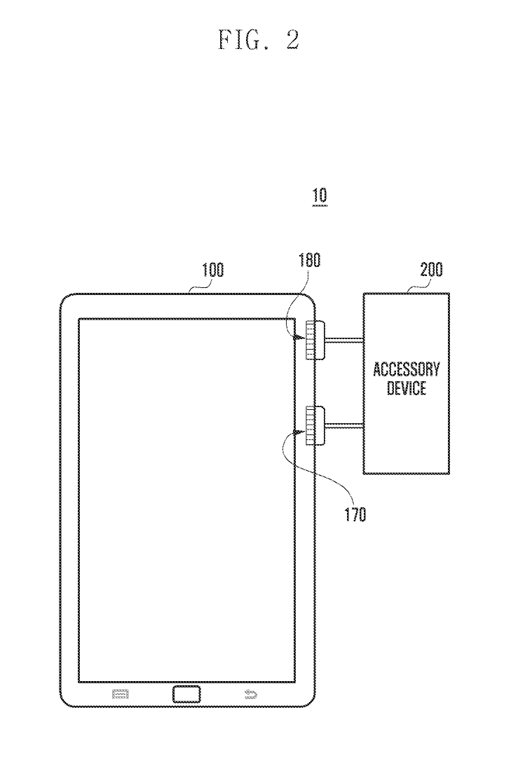

FIG. 1 is a diagram illustrating a configuration of a system for operating an accessory in a terminal according to an exemplary embodiment of the present invention. FIG. 2 is a diagram illustrating a configuration of another example of a system for operating an accessory in a terminal according to an exemplary embodiment of the present invention.

Referring to FIGS. 1 and 2, a system 10 for operating an accessory device 200 in a terminal 100 is shown. In the system 10, the terminal 100 is connected to the accessory device 200 through a plurality of ports, so that the terminal 100 may variously differentiate various key inputs signals from the accessory device 200. Accordingly, the system 10 may variously differentiate key input signals provided from the accessory device 200 in an operation of the terminal 100, so that a specific user function supported from the terminal 100 and a specific user function supported from the accessory device 200 may be easily controlled.

The terminal 100 includes various constituent elements, and supports various terminal functions according to a user request. For example, the terminal may include a module for supporting a file playback function, a file search function, a call function, a server access function, a camera function, and a broadcasting receiving function, and may support corresponding functions based thereon. The terminal 100 may include a Universal Serial Bus (USB) port 170 or a Micro USB (uUSB) for connection with the accessory device 200, and an ear jack port 180. The terminal 100 may connect with the accessory device 200 using the USB port 170 and the ear jack port 180. A configuration of the terminal 100 will be described with reference to the accompanying drawings.

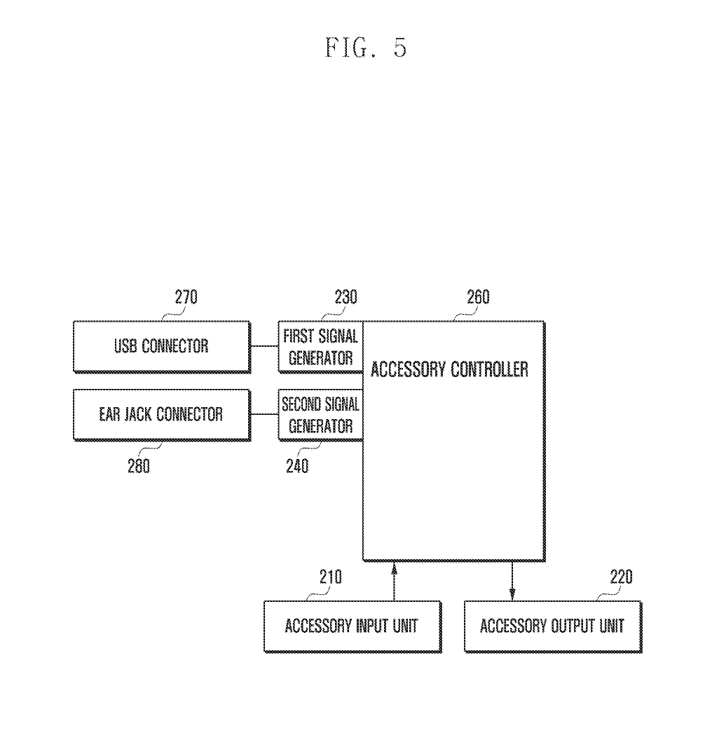

The accessory device 200 is connected to the terminal 100 to support a specific function of the terminal 100. Referring to FIG. 1, the accessory device 200 may be a speaker device in the cradle form simultaneously accessible to the USB port 170 and the ear jack port 180 of the terminal 100. Referring to FIG. 2, the accessory device 200 simultaneously accesses the USB port 170 and the ear jack port 180 of the terminal 100 to be a device for supporting a specific function of the terminal 100, for example, a device for supporting a file edit function, or a key input device for controlling file search or playback of the terminal 100. The accessory device 200 simultaneously accesses the USB port 170 and the ear jack port 180 of the terminal 100 and may vary a resistance among specific resistances in order to differentiate key input signals according to a user input. A configuration of the accessory device 200 will be described with reference to FIG. 5 further below.

As described above, in the system 10 for operating an accessory device 200 according to the exemplary embodiment of the present invention, the terminal 100 connects with the accessory device 200 through the USB port 170 and the ear jack port 180, recognizable key input signals by the terminal 100 may be diversified by controlling variation in a resistance in each port. Accordingly, although various key input units are provided at the accessory device 200, the system 10 for operating an accessory may separately operate key input signals generated from corresponding key input units.

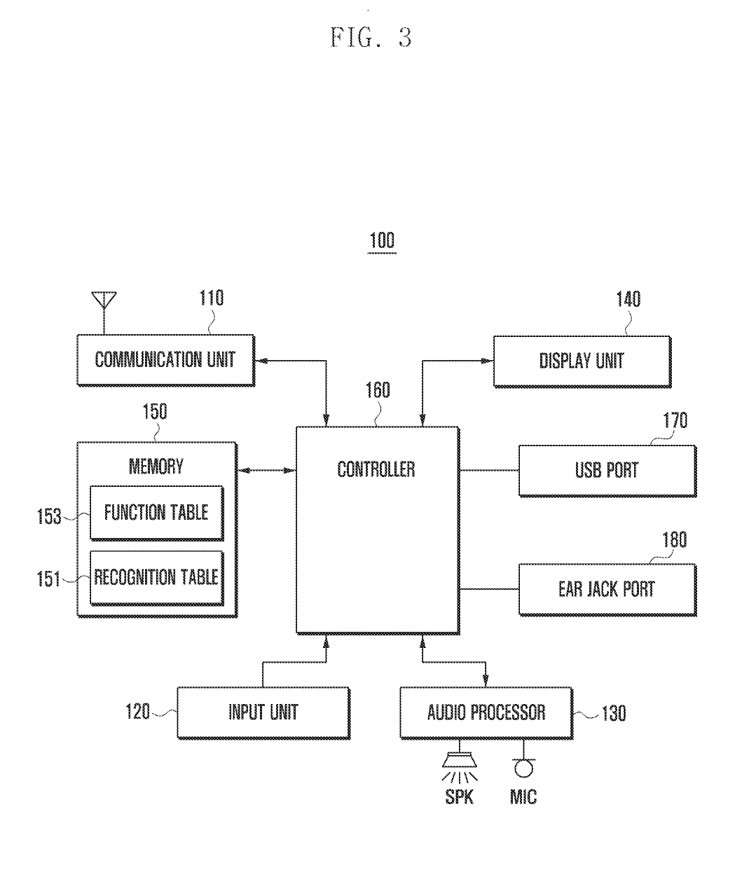

FIG. 3 is a block diagram illustrating a configuration of a terminal, such as the terminal shown in FIG. 1 or 2, according to an exemplary embodiment of the present invention.

Referring to FIG. 3, the terminal 100 may include a communication unit 110, an input unit 120, an audio processor 130, a display unit 140, a memory 150, a USB port 170, an ear jack port 180, and a controller 160.

If the terminal 100 having a construction as described above connects with the accessory device 200 through the USB port 170 and the ear jack port 180, the terminal 100 detects variations among specific resistances corresponding to the key input signal generated from the accessory device 200 through the USB port 170 and the ear jack port 180 to differentiate a corresponding key input signal. Accordingly, the terminal 100 may differentiate key input signals of the accessory device 200 corresponding to multiplication of the number of resistance variation values at the USB port 170 and the number of resistance variation values at the ear jack port 180. With respect to an external accessory connected by the terminal 100 through a predetermined port, a range of resistance variations capable of being differentiated based on characteristics of a hardware device is limited to the predetermined number. For example, the number of recognizable key input signals by the USB port 170 or the ear jack port 180 is limited to the predetermined number. However, since the present exemplary embodiment transfers the resistance variations through two ports, a large number of external key input signals may be differentiated. For example, when the number of recognizable variations in resistance through the USB port 170 is 15, and the number of resistance variations recognizable through the ear jack port 180 is 7, the terminal 100 may differentiate a total of 105 external key input signals through the two ports. Accordingly, the terminal 100 may differentiate various external key input signals and process a corresponding function.

The communication unit 110 may form a communication channel with another user terminal or an external specific server through a communication network device. The communication unit 110 may include communication modules of various forms or schemes according to communication characteristics of the terminal 100. For example, the communication unit 110 is not limited to specific communication technology or scheme such as various communication modules for supporting communication schemes for each generation such as 2nd Generation (2G), 3rd Generation (3G), 4th Generation (4G), and 5th Generation (5G), a communication module for supporting a communication scheme such as Time Division Multiple Access (TDMA), Code Division Multiple Access (CDMA), Wideband Code Division Multiple Access (WCDMA), Frequency Division Multiple Access (FDMA), Orthogonal Frequency Division Multiple Access (OFDMA), and a wired/wireless network based communication module but may be configured as a communication module capable of supporting reception of communication based service related information. When the terminal 100 does not support a communication function, the communication unit 110 may be omitted. Meanwhile, a message or an image received by the communication unit 110 may be outputted through the display unit 140, and may be transferred to the accessory device 200 according to connection of the accessory device 200. For example, a specific server providing page received by the communication unit 110 and various contents included in a corresponding page may be transferred to the accessory device 200 through the USB port 170.

The input unit 120 may generate various input signals used to operate the terminal 100. The input unit 120 may be provided in the form of a specific key such as a button key, a side key, and a home key, or in the form of a touch map for supporting a full touch screen. The touch map is displayed on the display unit 140 to generate an input signal according to user touch. The input unit 120 may generate an input signal for controlling the accessory device 200 according to the exemplary embodiment of the present invention under the control of the user after connection of the accessory device 200. For example, when the accessory device 200 is a speaker device, the input unit 120 may generate an input signal for adjusting a volume of a speaker of the accessory device 200. When the accessory device 200 is a device for playing a moving image, an image, or e-book contents, the input unit 120 may generate various input signals for controlling a screen outputted on the accessory device 200, for example, input signals corresponding to pause, playback, rapid rewind, and fast forward of a moving image, searching other image or contents, and page turning of e-book contents under the control of the user, etc. The generated input signals are transferred to the controller 160 and may be operated as a command for performing a corresponding function.

The audio processor 130 may process and collect various audio signals associated with the terminal 100. To this end, the audio processor 130 may include a speaker SPK for outputting an audio signal and a microphone MIC for collecting the audio signal. The audio processor 130 may be activated or inactivated according to characteristics of the accessory device 200. For example, when the terminal 100 connects with the accessory device 200 in the form of the speaker device, the audio processor 130 may block an audio output function and may selectively activate only a MIC function. When the speaker device includes the MIC function, the MIC function supported from the audio processor 130 may be blocked. When the accessory device 200 in the form of an image output device is connected to the terminal 100, the speaker SPK of the audio processor 130 may be activated to output an audio signal according to an image output.

The display unit 140 provides various screens used to operate the terminal 100. The display unit 140 may include a touch panel and a display panel to support a touch function. The display unit 140 may adopt at least one of various flat panel displays such as a Liquid Crystal Display (LCD) or an Organic Light Emitting Diode (OLED). Particularly, when the accessory device 200 is connected, the display unit 140 may provide various screen interfaces associated with connection of the accessory device 200. For example, when the accessory device 200 is connected, the display unit 140 may output information about a type of the connected accessory device 200 and other product information. When the accessory device 200 is a speaker device, the display unit 140 may support a screen interface associated with output control of the audio signal output through the accessory device 200. If a key input signal is generated and transferred from a key input unit included in the accessory device 200, the display unit 140 may output transferred key input signal information.

The memory 150 may store various application programs used to operate the terminal or to support a function of a specific terminal. For example, the memory 150 may support an operating system for operating the terminal 100, a call function support program for call connection, an image call function support program for supporting an image call upon support of the image call, and a server access support program for accessing an external server. Particularly, the memory 150 stores a function table 153 and a recognition table 151 to support a function according to the connection of the accessory device.

The recognition table 151 may be a table defining which input signal in the accessory device 200 corresponds to a resistance variation value transferred through the USB port 170 and the ear jack port 180. For example, when the accessory device 200 generates and transfers an input signal for searching for contents, the terminal 100 may receive a corresponding resistance variation value from the USB port 170 and the ear jack port 180. In order to support such an environment, the recognition table 151 may include information defining that the corresponding variation value in resistance is an input signal corresponding to a contents search in the accessory device 200. As described above, the recognition table 151 may store information defining a variation value in resistance in the form of a table corresponding to various key input signals provided from the accessory device 200. The recognition table 151 may be provided by the accessory device 200.

The function table 153 may be a table defining which function is executed with respect to a key input signal in the accessory device defined from the recognition table 151. That is, the function table 153 may be a table storing commands to be processed by the terminal 100 corresponding to the key input signal received from the accessory device 200. For example, the function table 153 may be a table including commands to be processed for searching for other contents by the terminal 100 when a key input signal for searching for the other contents is received from the accessory device 200. The function table 153 may be a table storing commands to be processed with respect to all of the key input signals that may be defined in the accessory device 200 by the terminal 100. The function table 153 may be provided by the accessory device 200.

Although the foregoing exemplary embodiment has separately illustrated the function table 153 and the recognition table 151, the function table 153 and the recognition table 151 may be constructed as one table. That is, the function table 153 and the recognition table 151 may be constructed as one table where commands to be performed by the terminal are mapped to resistance variation values provided from the USB port 170 and the ear jack port 180.

The USB port 170 is a port for supporting connection of a USB connector of the accessory device 200. As illustrated above, the USB port 170 may include not only a general USB port but also a micro USB port. Data transceiving may be supported between the terminal 100 and the accessory device 200 through the USB port 170. Particularly, an IDentifier (ID) pin of the USB port 170 may be used to differentiate key input signals of the accessory device 200.

The ear jack port 180 supports connection of an ear jack connector of the accessory device 200. The ear jack port 180 may be configured in any of various forms according to intention of a designer. For example, the ear jack port 180 may have a cylindrical shape with a predetermined diameter. The ear jack port may include a connector in which a plurality of pins having an accessible intagliated cuboid shape is mounted. That is, the ear jack port 180 may be provided with a shape corresponding to a shape of the ear jack connector provided at the accessory device 200. The ear jack port 180 may be provided with a shape capable of recognizing connection of a left terminal, a right terminal, a ground terminal, and a microphone terminal Particularly, in an accessory device except for a device using a microphone terminal such as an earphone or a headset, the microphone terminal may perform a function of a terminal in which a variation value in resistance according to generation of a key input signal from a corresponding device is detected. The left terminal and the right terminal may be used as a terminal detecting the variation value in resistance for differentiating key input signals generated from the accessory device 200 according to an intention of the designer.

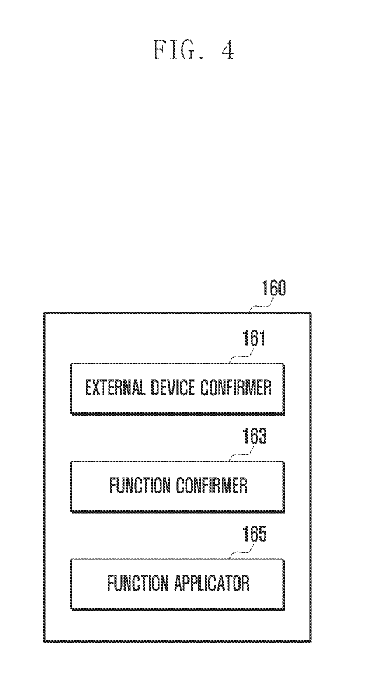

The controller 160 controls a supply and distribution of power, and transfers and processes signals used to operate the terminal 100. The controller 160 may support a function according to a key input signal in the accessory device. To this end, the controller 160 may include constituent elements as shown in FIG. 4.

FIG. 4 is a block diagram illustrating a configuration of a controller, such as the controller shown in FIG. 3, according to an exemplary embodiment of the present invention.

Referring to FIG. 4, the controller 160 may include an external device confirmer 161, a function confirmer 163, and a function applicator 165.

The external device confirmer 161 determines a type of the accessory device 200 connected to the USB port 170 and the ear jack port 180. To this end, the external device confirmer 161 may determine a type of the accessory device 200 using at least one of the USB port 170 and the ear jack port 180. For example, the external device confirmer 161 may perform data transceiving for determining the accessory device 200 through the USB port 170, and may then determine a type of the accessory device 200 based on the transceived data. The external device confirmer 161 may determine a type of the accessory device 200 through the ear jack port 180. For example, the external device confirmer 161 may determine the type of the accessory device 200 through the basic resistance variation of the accessory device 200 connected to the ear jack port 180. To this end, the terminal 100 may store a database with respect to types of the accessory device 200 according to basic resistances. The external device confirmer 161 may determine a type of a corresponding device through the basic resistance variation of the accessory device 200 connected to the ear jack port 180 with reference to the database. If the type of the accessory device 200 is determined, the external device confirmer 161 may transfer information about a corresponding type to the function confirmer 161 and the function applicator 165.

When receiving the information about the type of the accessory device 200 from the external device confirmer 161, the function confirmer 163 accesses a recognition table 151 according to the type of the accessory device 200. The function confirmer 163 confirms resistance variation generated through the USB port 170 and the ear jack port 180, and detects information mapped to the resistance variation from the recognition table 151. The detected matching information may be transferred to the function applicator 165. That is, the function confirmer 163 may receive the variation in resistance corresponding to a specific key input signal from the accessory device 200 through the USB port 170 and the ear jack port 180, and determine which key input signal of the accessory device 200 corresponds to the variation in the resistance. For example, the classification of key input signals of the accessory device 200 by the function confirmer 163 may be achieved through an ID pin of the USB port 170 and a microphone terminal of the ear jack port 180. First, if a key input is generated after connection of the accessory device 200, the terminal 100 may generate voltage variation according to the resistance variation of the microphone terminal in the ear jack port 180. Then, the function confirmer 163 primarily classifies a key of the accessory device 200 through voltage variation of the microphone terminal. The function confirmer may determine voltage variation in an ID pin of the USB port, and secondarily differentiate a key of the accessory device 200 through voltage variation of a corresponding ID pin. This will be described with reference to a following Table 1

TABLE 1

| | MIC | | | | |
|---|---|---|---|---|---|
| USB (ID) | 4.7 KΩ | 10 KΩ | 13 KΩ | . . . | 30 KΩ |
| 1 Ω | 1 | 5 | 9 | . . . | % |
| 2 Ω | 2 | 6 | @ | . . . | & |
| 3 Ω | 3 | 7 | # | . . . | * |
| 4 Ω | 4 | 8 | $ | . . . | ! |
| . . . | . . . | . . . | . . . | . . . | |
| 15 Ω | << | >> | < | > | ▪ |

Table 1 illustrates a classification of key input signals generated from the accessory device 200. Referring to Table 1, the function confirmer 163 primarily determines variation in resistance detected from the microphone terminal of the ear jack port 180 to differentiate a primary key of the accessory device 200. The function confirmer 163 determines variation in resistance detected from the ID pin of the USB port 170 to secondarily differentiate a key of the accessory device 200, thereby differentiating key input signals generated from the accessory device 200. Meanwhile, the function confirmer 163 preferentially makes a determination based on an ID pin of the USB port 170 to primarily differentiate a key of the accessory device 200, and then makes a determination based on the microphone terminal of the ear jack port 180 to secondarily differentiate the key of the accessory device 200. Meanwhile, while the foregoing exemplary embodiment and Table 1 have discussed variation in resistance generated from the ID pin of the USB port 170, signal variation for differentiating a key may similarly be differentiated through classification of a voltage or current.

When receiving type information of the accessory device 200 from the external device confirmer 161, the function applicator 165 accesses a function table 153 corresponding to the corresponding type of the accessory device 200. The function applicator 165 may determine function execution commands of the terminal 100 corresponding to matching information received from the function confirmer 163, for example, a key input signal. After that, the function applicator 165 may control the terminal 100 such that a specific terminal function is executed using the function execution commands of the terminal 100. For example, the function applicator 165 may increase, reduce, or mute a volume of an audio signal to be transmitted to the accessory device 200. The function applicator 165 may convert contents to be transmitted to the accessory device 200 into other contents, and may transmit a playback image of the converted contents to the accessory device 200. Execution of the function of the terminal 100 by the function applicator 165 may be implemented by various processing according to a key input signal from the accessory device 200. The implemented function may be transferred to the accessory device 200 or be realized by the terminal 100 according to a user setting.

FIG. 5 is a block diagram illustrating a configuration of an accessory device according to an exemplary embodiment of the present invention.

Referring to FIG. 5, the accessory device 200 may include an accessory input unit 210, an accessory output unit 220, a first signal generator 230, a second signal generator 240, an USB connector 270, an ear jack connector 280, and an accessory controller 260.

The accessory input unit 210 may include a plurality of key buttons. The key buttons may be implemented in a matrix pattern, and may be provided in at least a partial region of a side, a rear surface, or a front surface of the accessory device 200.

The accessory input unit 210 may include a key button for controlling a function of the accessory device 200, and may particularly include a key button for controlling a function of the terminal 100. A signal generated from a key button for controlling a function of the terminal 100 among the key buttons included in the accessory input unit 210 is transferred to the controller 260 so that the signal may be used to generate signals of the first signal generator 230 and the second signal generator 240.

The accessory output unit 220 may output a function according to characteristics of the accessory device 200. For example, the accessory output unit 220 may output data from the terminal 100, for example, at least one of audio data and video data. The accessory output unit 220 may be a speaker, a monitor, or a keypad according to the type of the accessory device 200. When the accessory output unit 220 is configured as the speaker, higher quality production may be achieved as compared with a speaker of the audio processor 130 provided at the terminal 100. When the accessory device is a monitor device, the accessory output unit 220 may be a display unit, and accordingly may output an image provided from the terminal 100.

The signal generator 230 supports such that a first signal may be detected from the USB port corresponding to a key input signal provided from the accessory input unit 210 under the control of the accessory controller 260. For example, the first signal generator 230 may include at least one switch and a plurality of resistors connected to the at least one switch in parallel. In the first signal generator 230, a plurality of resistors may be arranged in a matrix pattern, and at least one switch may be arranged at a crossing point of the resistors. The first signal generator 230 may be configured as a variable resistor. The first signal generator 230 may control a switch so that resistance corresponding to a key input signal is connected to the USB port through the USB connector 270. Specific resistances of respective resistors, specific resistor patterns, and a variable resistor may be set corresponding to each key input signal of the accessory input unit 210.

The second signal generator 240 supports such that the ear jack port 180 may detect a second signal corresponding to a key input signal provided from the accessory input unit 210 under the control of the accessory controller 260. As in the first signal generator 230, the second signal generator 240 may be configured as at least one of least one switch and a plurality of resistors connected to the at least one switch in parallel, a plurality of resistors arranged in a matrix pattern and at least one switch arranged at a crossing point of the resistors, and a variable resistor in which resistance may be changed within a predetermined range. The second signal generator 240 may control a switch so that resistance corresponding to a key input signal is connected to the ear jack portion through the ear jack connector 280. Specific resistances of respective resistors, specific resistor patterns, and a variable resistor may be set corresponding to each key input signal of the accessory input unit 210.

As a result, the first signal generator 230 and the second signal generator 240 may support such that resistances corresponding to a first signal and a second signal corresponding to one key input signal from the accessory input unit 210 are connected to ports of the terminal 100, respectively. The connected resistances may have previously defined values to differentiate respective key input signals of the accessory input unit 210.

The USB connector 270 connects the first signal generator 230 to the USB port 170 of the terminal 100. The USB connector 270 may be implemented in the form of a connector that is inserted into the USB port 170.

The ear jack connector 280 connects the second signal generator 240 to the ear jack port of the terminal 100. The ear jack connector 280 may have a shape corresponding to the ear jack port 180, for example, a specific type such as a bar type in which a pin is mounted and a cylindrical protruded type to be inserted into the ear jack port 180.

The accessory controller 260 supports a function of the accessory device 200, and controls such that a key input signal generated from the accessory input unit 210 is transferred to the terminal 100. If the accessory device 200 is connected to the terminal 100 through the USB port 170 and the ear jack port 180, the accessory controller 260 may output at least one of audio data and video data provided from the terminal 100 according to a configured device. When the accessory device 200 is configured as a speaker, the accessory controller 260 may control such that audio data provided from the terminal 100 is outputted.

Particularly, when a specific key button is pressed at the accessory input unit 210, the accessory controller 260 controls the first signal generator 23 and the second signal generator 240 to transfer a key input signal corresponding to the pressed key button to the terminal 100. For example, the accessory controller 260 may control the first signal generator 230 and the second signal generator 240 to connect resistances corresponding to a key input signal pressed at the accessory input unit 210 that are connected to the USB port 170 and the ear jack port 180 of the terminal 100. Accordingly, the terminal 100 may confirm resistance variations in the ear jack port 180 and the USB port 170 and voltage variation according thereto, and may control such that a function corresponding to the key input signal is performed using previously defined recognition table 151 and function table 153. Meanwhile, the foregoing exemplary embodiment has illustrated that the first signal generator 230 and the second signal generator 240 are arranged at a region separated from the accessory input unit 210, but the present invention is not limited thereto. For example, the first signal generator 230 and the second signal generator 240 may be disposed under the accessory input unit 210 during an implementation procedure. Accordingly, when the specific key button is pressed at the accessory input unit 210, the first signal generator 230 and the second signal generator 240 are connected to the terminal 100 through the USB connector 270 and the ear jack connector 280 due to pressed pressure.

To this end, switches may be arrange under key buttons, respectively, and the accessory device 200 may change resistances connected by the first signal generator 230 and the second signal generator 240 according to on-off operation of each switch. In this case, the accessory controller 260 may not control a separate operation associated with transfer of a key input signal. As a result, the accessory input unit 210 provided at the accessory device 200 may include a hardware device supporting such that resistance or a voltage provided through the ear jack connector 280 and the USB connector 270 varies corresponding a pressed key button.

The accessory input unit 210 may be provided in the form of a touch screen or a touch pad as well as the form of a key button. In this case, the accessory controller 260 controls resistance variations of the first signal generator 230 and the second signal generator 240 corresponding to a key input signal pressed at the accessory input unit 210 so that the foregoing key input signal may be transferred. Accordingly, the present invention is not limited to a shape or hardware device of the accessory input unit 210 of the accessory device 200, but the present invention is characterized that the accessory device 200 may transfer the input signal to the terminal using at least two ports, such as both the USB port 170 and the ear jack port 180.

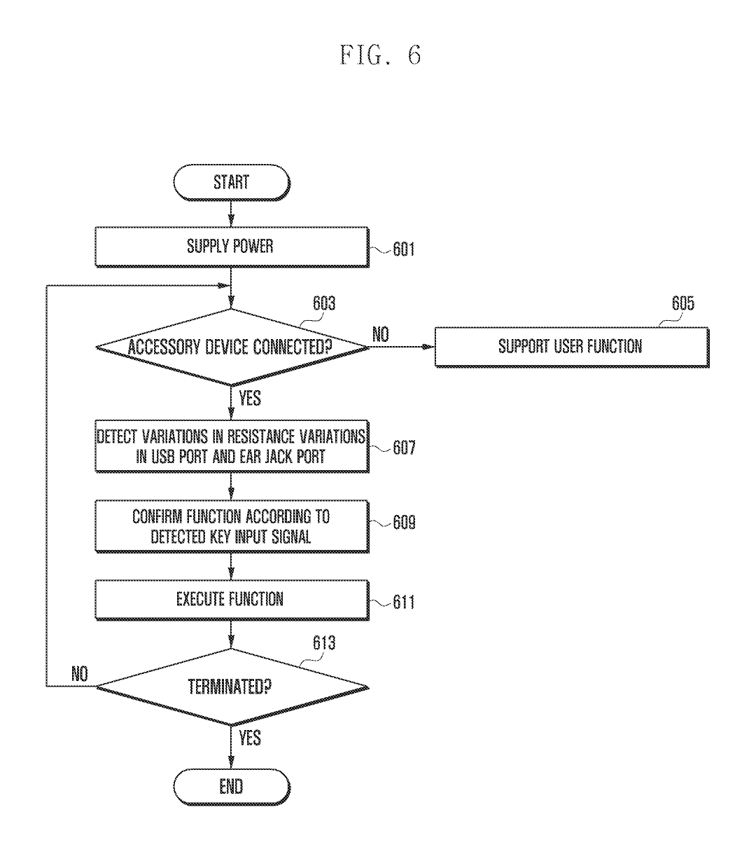

FIG. 6 is a flowchart illustrating a method of operating an accessory in a terminal according to an exemplary embodiment of the present invention.

Referring to FIG. 6, in the method of operating an accessory, power used for respective constituent elements of the terminal 100 may be supplied based on power supplied to the terminal 100 in step 601. Particularly, the terminal 100 may supply power to support confirming a connection between the USB port 170 and the ear jack port 180 for differentiating key input signals of the accessory device 200, the detection of resistance variation of the accessory device 200 input through corresponding ports, and performing a function of the terminal 100 corresponding to the detected variation in the resistance.

Next, the terminal 100 may determine whether the accessory device 200 is connected in step 603. When the accessory device 200 is not connected at step 603, the controller 160 of the terminal 100 may support a terminal function, for example, a specific user function in step 605. For example, the controller 160 may support a specific function such as a call function, a server access function, a file playback function, a camera function, and a broadcasting receiving function supportable from the terminal 100 according to user control.

When the accessory device 200 is connected at step 603, the controller 160 detects resistance variation values in the USB port 170 and the ear jack port in step 607. The controller 160 may detect voltage or current variation values in the USB port and the ear jack port 180. Meanwhile, the controller 160 may detect resistance variation in a microphone terminal of the ear jack port 180 to primarily differentiate a key of the accessory device 200, and may detect resistance variation in an ID pin of the USB port 170 to secondarily differentiate the key of the accessory device 200. The controller 160 may preferentially inspect resistance variation in the ID pin of the USB port 170 and detect resistance variation of the microphone terminal of the ear jack port 180 to differentiate the key input signal generated from the accessory device 200. In addition, the controller may detect resistance and voltage variations for differentiating the key of the accessory device 200 using at least one of the other terminals of the ear jack port 180, for example, a left earphone terminal, and a right earphone terminal. The controller 160 may detect resistance or voltage variation for differentiating the key of the accessory device 200 using a data pin in the USB port 170.

Meanwhile, to support connection of a plurality of the accessory device 200 and a function according thereto, if the accessory device 200 is connected during a procedure of performing step 607, the controller 160 may determine the type of the accessory device 200 through at least one of the ear jack port 180 and the USB port 170, and may access a recognition table 151 corresponding to the type of the corresponding accessory device 200. During the procedure, the terminal 100 may previously store recognition tables 151 by the accessory device 200.

Based on the corresponding resistance variation or voltage variation in the recognition table 151, the controller 160 confirms a function according to the detected key input signal in step 609. To this end, the controller may access the function table 153. The function table 153 may be a table defining a function to be executed by the terminal 100 according to the key input signal provided from the accessory device 200. Like the function table 153 or the recognition table 151, the function table 153 may be provided by the accessory device 200. If the type of the accessory device is confirmed at step 607, the controller 160 may control such that a function table 153 corresponding to the accessory device 200 is accessed to support the function of the accessory device 200.

Next, the controller 160 executes the function with reference to a corresponding function table 153 in step 611. For example, the controller 160 may perform an image call with another terminal having a specific phone number or corresponding specific phone book information according to input signals from the accessory device 200. In this case, the terminal 100 may activate a camera to collect an image and support transceiving with the other terminal, and may output audio data among them through the accessory device 200. When the accessory device 200 includes a microphone, a microphone function provided at the terminal 100 may be turned-off according to a user setting, and a collected audio signal may be transmitted to the terminal 100 through another terminal. The controller 160 may control a broadcasting receiving function of the terminal 100 according to an input signal from the accessory device 200, output video data of the received broadcasting data through a display unit 140 of the terminal, and outputs audio data through a speaker of the accessory device 200. The accessory input unit 210 may generate various input signals for control the foregoing image call and broadcasting receiving function. To this end, previously defined keypad, key buttons, and a touch screen may be provided at the accessory device 200 for generating a corresponding input signal.

In addition, the controller 160 may display a contents image for a file edit function of the terminal 100. In this case, the accessory device 200 may generate various signals for editing the content image of the terminal 100. The generated input signal may be transferred to the terminal through the USB port 170 and the ear jack port 180, and the terminal 100 may edit a file according to the transferred input signal and output a corresponding image. During this procedure, the accessory device 200 may be provided as a configuration for generating an input signal to support the file edit function. When the terminal supports a network control function, the accessory device 200 may include a key pad, key buttons, and a touch screen having a key map capable of controlling respective home network devices, for example, refrigerator, washing machine, air conditioner, gas range, or oven, and may generate and transfer input signals for controlling the respective devices to the terminal 100. The terminal 100 may support message transmission and operation control for controlling respective home network devices according to the input signal from the accessory device 200.

Next, the controller 160 may determine whether an input signal or device control for terminating a function of the terminal 100 or the accessory device 200 in step 613. When a separate termination event is not generated at 613, the controller 160 returns to step 603 and repeats the foregoing procedures.

Meanwhile, the foregoing exemplary embodiment has illustrated that the controller 160 separately performs step 607 and step 609, but the present invention is not limited thereto. For example, as described above, when the recognition table 151 and the function table 153 are configured as an integral type table, the controller 160 may process step 607 and step 609 as one step. That is, the controller 160 may confirm a function to be executed according to corresponding resistance variation together with detection of the resistance variation.

As describe above, the exemplary embodiments of the present invention may support such that a key of the accessory device 200 is recognized through at least two ports, such as the USB port and the ear jack port, so that various keys of the accessory device 200 can be installed and operated.

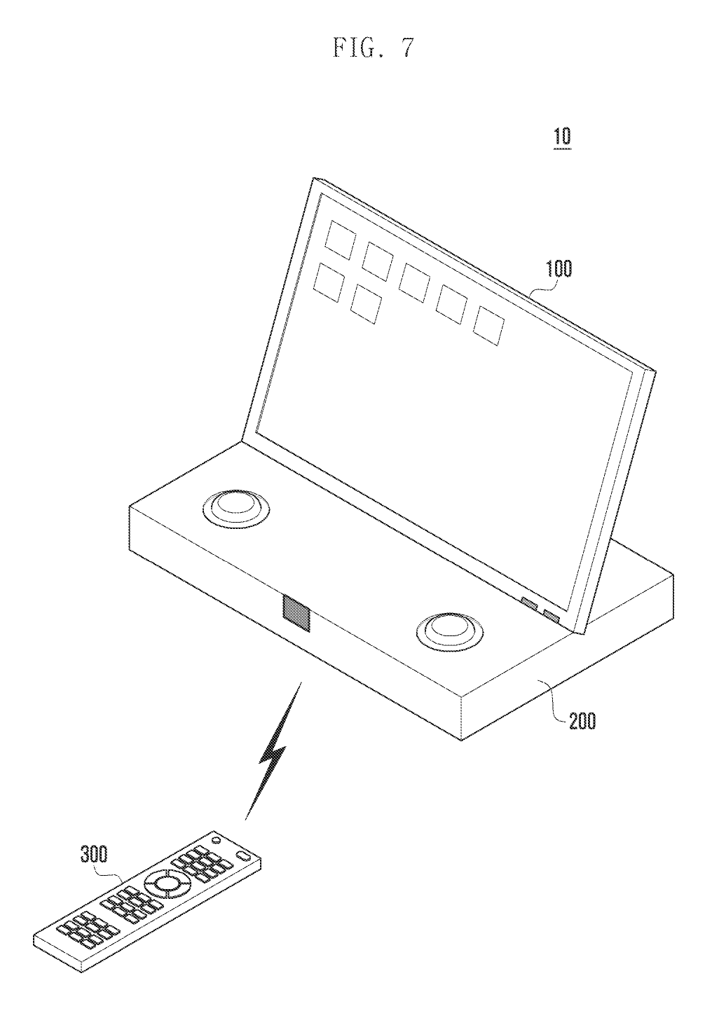

FIG. 7 is a diagram illustrating a configuration of an example of a system for operating an accessory in a terminal according to another exemplary embodiment of the present invention.

Referring to FIG. 7, the system 10 for operating an accessory in the terminal according the second exemplary embodiment of the present invention may include a terminal 100, a first accessory device 200, and a second accessory device 300.

In the system 10 for operating an accessory in the terminal having a construction mentioned above, the terminal 100 is connected to the first accessory device 200, and the first accessory device 200 may be connected to the second accessory 300 in a wireless scheme. For example, the second accessory device 300 may include a remote controller as a configuration including an input unit. In the system 10 for operating an accessory, if the user controls the second accessory device 300 to transfer a specific input signal to the first accessory device 200, the first accessory device 200 may control a first signal generator 230 and a second signal generator 240 to a resistance variation value corresponding to the specific input signal to the terminal 100.

As described above, the system for operating an accessory in the terminal supports the accessory device 200 to generate various input signals, so that an input signal used by the user may be widely supported.

The foregoing terminal 100 may further include various additional modules according to provision forms. That is, when the terminal 100 is a communication terminal, it may include constructions that are not mentioned herein such as a near distance communication module for near distance communication, an interface module for exchanging data in a wired communication scheme or a wireless communication scheme of the terminal 100, an Internet communication module for communicating with an Internet to perform an Internet function, and a digital broadcasting module for receiving and broadcasting digital broadcasting. Since the structural elements can be variously changed according to convergence trend of a digital device, no elements can be listed. However, the terminal 100 may include structural elements equivalent to the foregoing structural elements. Further, the terminal 100 may be substituted by specific constructions in the foregoing arrangements according to the provided form or another structure. This can be easily understood to those skilled in the present art.

The terminal 100 according to the exemplary embodiments of the present invention may include various information and communication devices such as a Portable Multimedia Player (PMP), a digital broadcasting player, Personal Digital Assistant (PDA), a digital music player, a portable game terminal, a smartphone, a notebook computer, and a hand-held Personal Computer (PC) as well as various mobile communication terminals operating based on communication protocols corresponding to various communication systems.

As mentioned above, a method and a system for operating an accessory in a terminal, and a terminal supporting the same according to exemplary embodiments of the present invention, can enlarge a differentiating range of a key input signal capable of transceiving between the terminal and the accessory so that an operation and key input control of the accessory generating various key input signals can be supported.

While the invention has been shown and described with reference to certain exemplary embodiments thereof, it will be understood by those skilled in the art that various changes in form and details may be made therein without departing from the spirit and scope of the invention as defined by the appended claims and their equivalents.

What is claimed is:

1. A system for operating an accessory device in a terminal, the system comprising:
the terminal including a Universal Serial Bus (USB) port and an ear jack port; and
the accessory device simultaneously connecting with the USB port and the ear jack port of the terminal, and transferring a signal corresponding to a key input signal to the terminal through the USB port and the ear jack port.

2. The system of claim 1, wherein the terminal further comprises:
a controller for differentiating the key input signal through at least one of resistance variation, voltage variation, and current variation in an IDentifier (ID) pin of the USB port, and at least one of resistance variation, voltage variation, and current variation in a microphone terminal of the ear jack port; and
a memory for storing a recognition table defining the key input signal according to the at least one of the resistance variation, the voltage variation, and the current variation in the ID pin of the USB port, and the at least one of the resistance variation, the voltage variation, and the current variation in the microphone terminal of the ear jack port, and storing a function table defining a function to perform according to the key input signal.

3. The system of claim 2, wherein the controller determines a type of the accessory device through at least one of the USB port and the ear jack port, and to access the recognition table and the function table corresponding to the determined type of the accessory device.

4. The system of claim 1, wherein the accessory device comprises:
a USB connector and an ear jack connector connected to the USB port and the ear jack port, respectively;
an accessory input unit for generating the key input signal; and
a first signal generator and a second signal generator connected to the USB connector and the ear jack connector to set resistance variation corresponding to the key input signal.

5. The system of claim 4, wherein the first signal generator and the second signal generator comprise at least one of:
a switch;
a plurality of resistors connected to the switch in parallel and having resistances corresponding to the key input signal;
a plurality of switches and a plurality of resistors arranged in a matrix pattern to generate a resistance pattern corresponding to the key input signal; and
a variable resistor having resistance corresponding to the key input signal.

6. The system of claim 1, wherein the accessory device comprises:
a first accessory device coupled with the terminal in a wired scheme; and
a second accessory device connected to the first accessory device in a wireless scheme to generate the key input signal.

7. The system of claim 6, wherein the second accessory device comprises a remote controller.

8. A method of operating an accessory device in a terminal, the method comprising:
connecting a Universal Serial Bus (USB) connector and an ear jack connector of the accessory device with a USB port and an ear jack port of the terminal, respectively;
transferring a signal from the accessory device to the terminal through the USB port and the ear jack port, the signal corresponding to a key input signal received by the accessory device; and
differentiating, by the terminal, the key input signal of the accessory device based on the signal transferred through the USB port and the ear jack port.

9. The method of claim 8, wherein the transferring of the signal comprises:
determining the key input signal generated from an accessory input unit by an accessory controller; and
controlling a first signal generator arranged at the accessory device to be connected to the USB port and a second signal generator arranged at the accessory device to be connected to the ear jack port to set resistance variation corresponding to the key input signal.

10. The method of claim 9, wherein the first signal generator and the second signal generator comprise at least one of:
a switch;
a plurality of resistors connected to the switch in parallel and having resistances corresponding to the key input signal;
a plurality of switches and a plurality of resistors arranged in a matrix pattern to generate a resistance pattern corresponding to the key input signal; and
a variable resistor having resistance corresponding to the key input signal.

11. The method of claim 8, further comprising transmitting the key input signal to the accessory device including the USB connector and the ear jack connector in a wireless scheme.

12. The method of claim 11, wherein the transmitting of the key input signal comprises transmitting a specific key input signal from a remote controller to the accessory device.

13. The method of claim 8, wherein the differentiating of the key input signal of the accessory device comprises differentiating the key input signal through at least one of resistance variation, voltage variation, and current variation in an IDentifier (ID) pin of the USB port, and at least one of resistance variation, voltage variation, and current variation in a microphone terminal of the ear jack port.

14. The method of claim 8, further comprising storing a recognition table defining the key input signal according to at least one of resistance variation, voltage variation, and current variation by the accessory device and a function table defining a function to perform according to the key input signal.

15. The method of claim 14, wherein the differentiating of the key input signal of the accessory device comprises:
determining a type of the accessory device through at least one of the USB port and the each port;
accessing the recognition table and the function table corresponding to the determined type of the accessory device; and
differentiating the key input signal based on the recognition table.

16. The method of claim 15, further comprising:
determining a terminal function corresponding to the key input signal based on the function table; and
executing the terminal function.

17. A terminal for supporting an operation of an accessory device, the terminal comprising:
a Universal Serial Bus (USB) port;
an ear jack port; and
a controller for differentiating a key input signal of the accessory device based on at least one of resistance variation, voltage variation, and current variation detected via the USB port and the ear jack port when the accessory device simultaneously connects with the USB port and the ear jack port.

18. The terminal of claim 17, wherein the controller differentiates the key input signal of the accessory device based on at least one of the resistance variation, the voltage variation, and the current variation in an IDentifier (ID) pin of the USB port, and at least one of the resistance variation, the voltage variation, and the current variation in a microphone terminal of the ear jack port.

19. The terminal of claim 17, further comprising a memory for storing a recognition table defining the key input signal according to a corresponding one of the at least one of the resistance variation, the voltage variation, and the current variation, and storing a function table defining a function to perform according to the key input signal.

20. The terminal of claim 19, wherein the controller determines a type of the accessory device through at least one of the USB port and the ear jack port, and to access the recognition table and the function table corresponding to the determined type of the accessory device.
